(19) United States
(12) Patent Application Publication
(10) Pub. No.: US 2016/0123049 A1
(43) Pub. Date: May 5, 2016

(54) DOOR LOCK

(71) Applicant: ROLLOCK OY, Espoo (FI)

(72) Inventors: Hannu KANKKUNEN, Espoo (FI); Timo TOIVONEN, Helsinki (FI); Timo JUNTUNEN, Utajärvi (FI); Toivo PÄÄKKÖNEN, Nakertaja (FI); Marko Petteri KARJALAINEN, Kajaani (FI)

(73) Assignee: ROLLOCK OY, Espoo (FI)

(21) Appl. No.: 14/894,414

(22) PCT Filed: May 15, 2014
(86) PCT No.: PCT/FI2014/050365

§ 371 Date: Nov. 27, 2015

(30) Foreign Application Priority Data
May 29, 2013 (FI) 20135591

(51) Int. Cl. E05C 3/12

(52) U.S. Cl. CPC E05C 3/12

(57) ABSTRACT

Door lock including a pivoted latch with a striking plate disposed in the doorframe opposite the door, into which striking plate the pivoted latch is arranged to turn in the locking position; In addition, a locking slide for turning the latch is provided. Installed into the lock is a tightening part which directly or indirectly wedges the locking slide farther away and thereby turns the latch farther into the striking plate when the door is pushed closed.

The object of the present invention is a door lock, which comprises a pivoted latch, a striking plate disposed in the doorframe opposite the door, into which striking plate the pivoted latch is arranged to turn in the locking position, and also a locking slide turning the latch.

The invention thus relates to a pivoted latch lock, which means a lock in which the latch turns into a lock housing in the doorframe. These types of pivoted latch locks are known in the art, e.g. from Finnish patents 107824, 120243, 120841 and 121435.

In the locked position a door comes against the seals. Generally, however, the seals flex to the extent that the door is able to move slightly and might feel loose. If it is endeavored to press the door tighter, it returns to its earlier position.

The purpose of the present invention is to achieve a pivoted latch lock, which after locking can be further tightened even more tightly against the seals. The lock according to the invention is characterized in: that installed into the lock is a tightening part, which directly or indirectly wedges the locking slide farther away and thereby turns the latch farther into the striking plate when the door is pushed closed.

One preferred embodiment of the door lock according to the invention is characterized in that arranged in the lock between the tightening part and the locking slide is a counterpart of the tightening part, which counterpart transmits the movement of the tightening part to the locking slide and onwards to the pivoted latch.

A second preferred embodiment of the door lock according to the invention is characterized in that the front surface of the tightening part, which front surface comes against the counterpart, is curved.

Yet another preferred embodiment of the door lock according to the invention is characterized in that the front surface of the tightening part is a part of a circular rim.

One advantage of the invention that can be mentioned is that it is possible to tighten the door to be as tight as desired and in any case to be significantly tighter than earlier, in which case there is no unnecessary clearance. This also increases the sealing of the door.

In the following, the invention will be described in more detail by the aid of some preferred embodiments with reference to the attached drawings, wherein

FIG. 1 presents a three-dimensional and partially sectioned view of a lock according to the invention, said lock being in the open state.

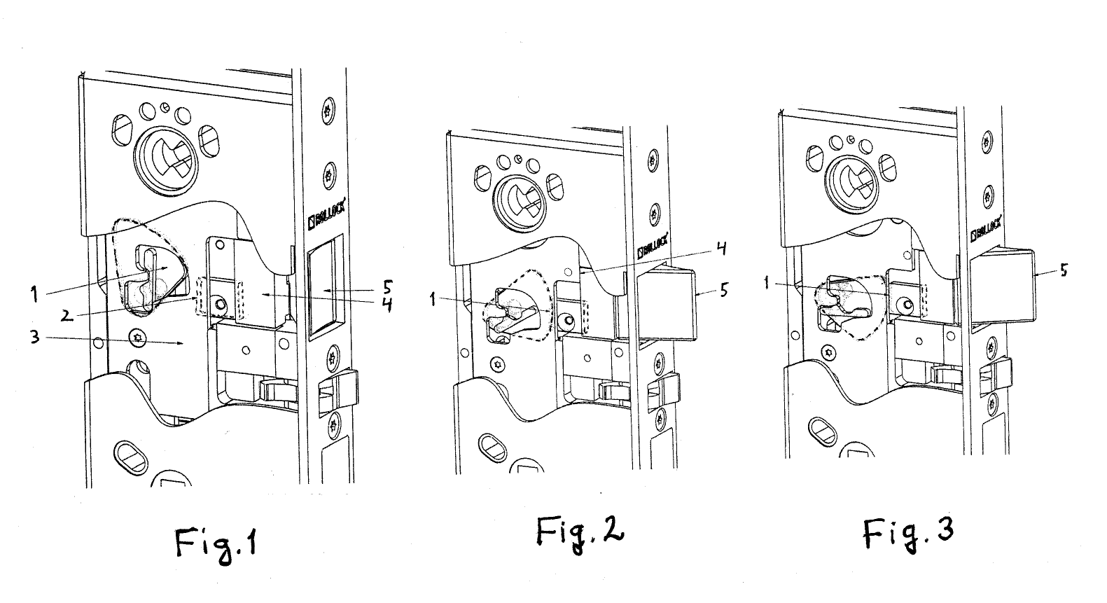

FIG. 2 presents the same as FIG. 1, but with the lock in the deadlocked state.

FIG. 3 presents the same as FIGS. 1 and 2, but with the lock in the tightened state.

FIG. 4 presents a side view of the structure of the lock case, in the open state.

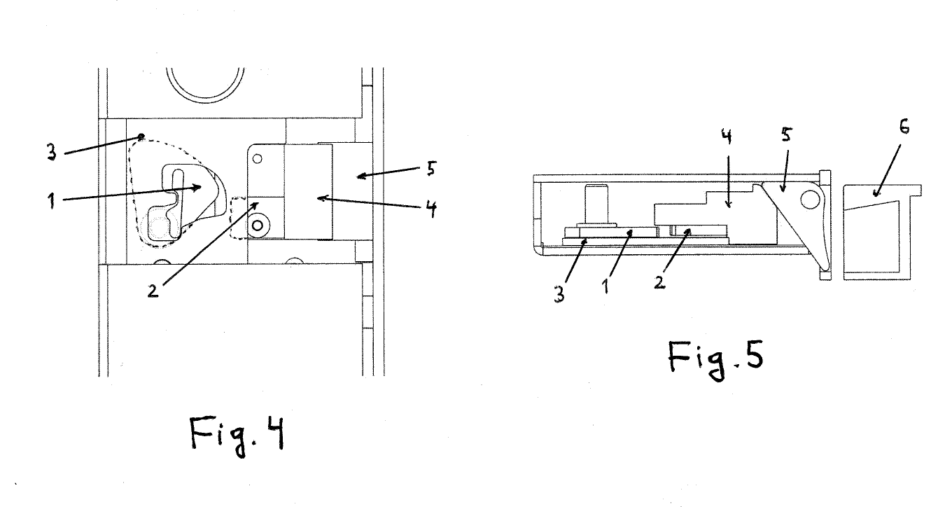

FIG. 5 presents a top view of the lock case and of the striking plate in the doorframe, in the open state.

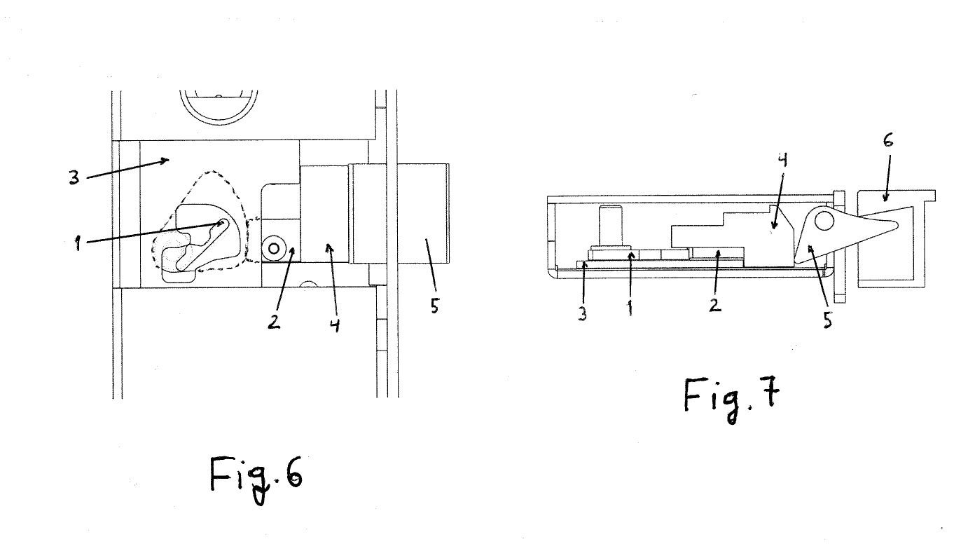

FIG. 6 presents a side view of the structure of the lock case, in the deadlocked state.

FIG. 7 presents a top view of the lock case and of the striking plate in the doorframe, in the deadlocked state.

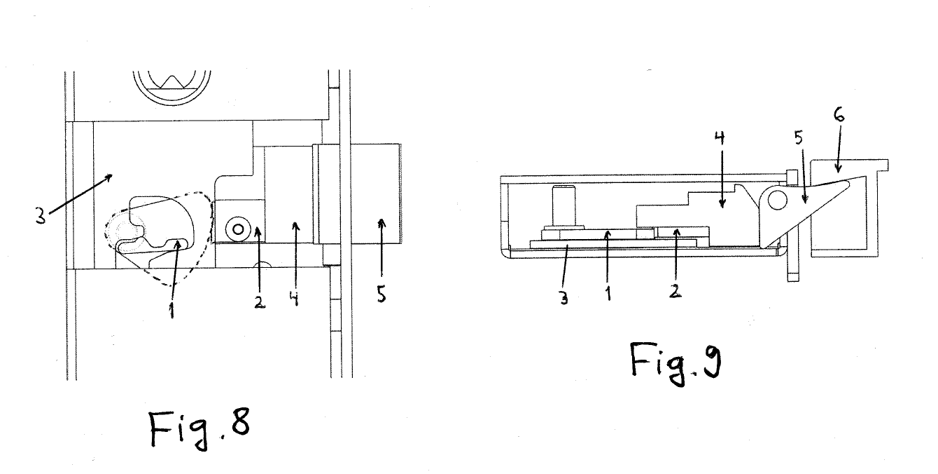

FIG. 8 presents a side view of the structure of the lock case, in the tightened state.

FIG. 9 presents a top view of the lock case and of the striking plate in the doorframe, in the tightened state.

FIG. 1 thus presents a lock according to the invention. In the lock is a pivoted latch 5, which in this figure is in the open state. When pressing the door closed, a separate trigger mechanism turns the latch 5 into the striking plate 6 of the doorframe (FIGS. 7 and 9). The trigger mechanism is not presented in this description or in the figures because it is per se prior art and is not of importance from the standpoint of the invention.

A locking slide 4 follows the pivoted latch, which locking slide in the tightened state is wedged with the tightening part 1 into the farthermost position that it attains when the door is pressed against the sealing of the doorframe. The tightening part 1 does not permit returning of the door backwards from the farthermost position before the locking is opened.

The deadlocking presented in FIGS. 2, 6 and 7 is brought about by the locking plate 3, the vertical part of which goes behind the locking slide 4 by means of spring force when the pivoted latch 5 has turned outwards sufficiently. The locking plate 3 also moves the tightening part 1.

When the door is opened, the locking plate 3 is lifted upwards with a key mechanism or handle mechanism and the locking plate 3 at the same time lifts the tightening part 1 out of the tightening position. The key mechanism and handle mechanism are not presented in more detail in this description because it can be per se prior art and is not itself essential from the standpoint of the invention.

In the deadlocked state the door is latched with the latch 5 into the striking plate 6 of the doorframe, but the door has not been pushed against the seals to as deep as the tightening mechanism allows it. The locking plate 3 in the lock has gone behind the locking slide 4 and the tightening part 1 comes into contact with its counterpart 2 (marked with dashed lines). The counterpart 2 can be a separate part or a part of the locking slide 4.

In FIGS. 3, 8 and 9 the locked is presented in a tightened state. In this case the latch 5 has turned even farther in the striking plate 6. The lock reaches this state when the door is pushed deeper into the doorframe after the deadlocking state. In the tightened state the tightening part 1 wedges the locking slide 4 into its farthermost position and this further turns the latch 5. The door is not able to return backwards from this position before the locking is opened. The locking and tightening parts of the lock are now in the so-called tightened state.

The tightening part 1 can be essentially triangular in such a way that the front surface of the tightening part 1, which front surface is against the counterpart 2, is made to be curved. The curvature can e.g. follow the shape of a part of a circular rim. In this context, triangular can also mean a shape having rounded corners. In addition, the tightening part has been installed in a pivoted manner in such a way that the curved head tries to descend downwards due to the force of gravity. This is brought about in such a way that the pivot point is in the farthermost corner of the triangle with respect to the curved front surface, or near said corner.

When the door is pressed by hand tighter than it normally is in the deadlocked state, the latch 5 is free to turn farther in the striking plate, which the tightening part 1 brings about by turning under the effect of gravity downwards, i.e. clockwise around the pivot point, and by wedging the counterpart 2 and, via it the locking slide 4, farther. In this way the locking slide 4 and thereby also the latch 5 lock into this farther position (FIG. 9) and the door stays in that position into which it has been pressed.

It is obvious to the person skilled in the art that the invention is not limited to the embodiments described above, but that it can be varied within the scope of the claims presented below. For example, the shape of the various parts can differ to the shapes presented in the drawings. What is essential is that that surface of the tightening part that wedges the counterpart 2 is able to descend from the effect of gravity downwards when its counterpart 2 gives way when pushing the door tighter. It is possible to arrange the tightening part also directly against the locking slide 4, in which case a counterpart of the tightening part is not needed.

The characteristic features possibly presented in the description in conjunction with other characteristic features can if necessary be used separately to each other.

1. Door lock, which comprises a pivoted latch, a striking plate disposed in the doorframe opposite the door, into which striking plate the pivoted latch is arranged to turn in the locking position, and also a locking slide turning the latch, wherein installed into the lock is a tightening part, which directly or indirectly wedges the locking slide farther away and thereby turns the latch farther into the striking plate when the door is pushed closed.

2. Door lock according to claim 1, wherein arranged in the lock between the tightening part and the locking slide is a counterpart of the tightening part, which counterpart transmits the movement of the tightening part to the locking slide and onwards to the pivoted latch.

3. Door lock according to claim 2, wherein the front surface of the tightening part, which front surface comes against the counterpart, is curved.

4. Door lock according to claim 3, wherein the front surface of the tightening part is a part of a circular rim.

5. Door lock according to claim 1, wherein the tightening part is essentially triangular.

6. Door lock according to claim 5, wherein the tightening part has been installed in a pivoted manner in such a way that the pivot point is in the farthermost corner with respect to the curved front surface, or near said corner.

7. Door lock according to claim 6, wherein the wedging function of the tightening part, i.e. the clockwise turning around the pivot point, has been arranged to occur from the effect of gravity when the door is pressed tighter and the pivoted latch, locking slide and counterpart are released to move.

8. Door lock according to claim 2, wherein the tightening part is essentially triangular.

9. Door lock according to claim 3, wherein the tightening part is essentially triangular.

10. Door lock according to claim 4, wherein the tightening part is essentially triangular.
